(19) United States
(12) Patent Application Publication
(10) Pub. No.: US 2010/0210775 A1
(43) Pub. Date: Aug. 19, 2010

(54) REINFORCED POLYESTER COMPOSITIONS HAVING IMPROVED TOUGHNESS

(75) Inventors: Gary Michael Stack, Kingsport, TN (US); Daniel Henry Bolton, Kingsport, TN (US)

Correspondence Address: MICHAEL K. CARRIER, EASTMAN CHEMICAL COMPANY, 100 NORTH EASTMAN ROAD, KINGSPORT, TN, 37660-5075, US

(73) Assignee: Eastman Chemical Company, Kingsport, TN (US)

(21) Appl. No.: 12/686,850

(22) Filed: Jan. 13, 2010

Related U.S. Application Data
(60) Provisional application No. 61/152,328, filed on Feb. 13, 2009.

(51) Int. Cl. C08K 3/34; C08L 67/02; C08K 3/26; C08K 3/36; C08K 3/30

(52) U.S. Cl. 524/420; 524/605; 524/451; 524/456; 524/449; 524/425; 524/445; 524/447; 524/444; 524/423

(57) ABSTRACT

Polymer compositions are disclosed that are blends of polyesters prepared from terephthalic acid, 2,2,4,4-tetramethyl-1,3-cyclobutanediol, and optionally 1,4-cyclohexanedimethanol, with a reinforcing mineral filler. The composition of the blend includes up to about 40 weight % of the mineral. These formulations have a combination of toughness, heat resistance, and high modulus making the materials particularly useful in engineering molding plastics.

This application claims priority to U.S. Provisional Application No. 61/152,328 filed Feb. 13, 2009, the disclosure of which is incorporated herein by reference in its entirety.

### FIELD OF THE INVENTION

This invention relates generally to polyester compositions, and more specifically, to reinforced polyester compositions of terephthalic acid, 2,2,4,4-tetramethyl-1,3-cyclobutanediol (TMCD), and optionally 1,4-cyclohexanedimethanol (CHDM), provided with one or more mineral fillers.

### BACKGROUND OF THE INVENTION

Inorganic mineral fillers are used to modify and reinforce various polymers. They enhance stiffness, heat resistance, and strength, and reduce shrinkage and cost. However, the addition of mineral fillers generally results in a significant decrease in the toughness of the polymer formulations relative to the neat polymer. This loss in toughness is manifested in the reduction of properties such as impact strength and tensile elongation at break.

U.S. Pat. No. 3,859,246 discloses formulations of polybutylene terephthalate and talc. The addition of at least 10% talc is said to increase the heat distortion temperature by at least 20° C.

U.S. Pat. No. 4,124,561 discloses reinforced thermoplastic polymers which comprise a high molecular weight polyester and a mineral reinforcing filler comprising mica, talc, or mixtures thereof in combination with a glass fiber reinforcement. The use of glass fibers together with the mineral reinforcement is said to provide shatter resistance and further enhances other physical properties, such as tensile strength, modulus, impact strength and heat distortion temperature.

US Pat. Appln. Pubin. Nos. 2006/0287479 and 2007/0010650 disclose polyesters prepared from terephthalic acid, 2,2,4,4-tetramethyl-1,3-cyclobutanediol, and 1,4-cyclohexanedimethanol. The publications suggest the use of common additives such as colorants; dyes; mold release agents; flame retardants; plasticizers; nucleating agents; stabilizers, including UV stabilizers, thermal stabilizers, and/or reaction products thereof; fillers; and impact modifiers.

There remains a need in the art for polyester compositions that provide the reinforcing properties of mineral fillers while maintaining satisfactory performance as evidenced, for example, by tensile elongation at break.

### SUMMARY OF THE INVENTION

In one aspect, the invention relates to polymer compositions that comprise a polyester having repeat units of 2,2,4,4, tetramethyl-1,3 cyclobutanediol, terephthalic acid, and optionally 1,4-cyclohexanedimethanol, blended with a mineral filler.

### DESCRIPTION OF THE FIGURES

FIG. 1 depicts the effect of talc addition on the tensile break elongation of polyesters.

FIG. 2 depicts the effect of CaCO3 addition on the tensile break elongation of polyesters.

FIG. 3 depicts the effect of wollastonite addition on the tensile break elongation of polyesters.

### DETAILED DESCRIPTION OF THE INVENTION

The present invention may be understood more readily by reference to the following detailed description of certain embodiments of the invention and the working examples.

Unless otherwise specified herein, particle size means median or average particle size. Particles of irregular shape may be defined by “esd” or equivalent spherical diameter.

According to one aspect of the present invention, there is provided a polymer formulation comprising:

(1) from about 60 to about 98 wt % of a polyester having repeat units from terephthalic acid, 2,2,4,4, tetramethyl-1,3 cyclobutanediol (trans or cis or mixtures thereof) and optionally 1,4 cyclohexanedimethanol(CHDM) (trans or cis or mixtures thereof); and

(2) from about 2 wt % to about 40 wt % of a mineral filler.

The polyester portion of this invention may thus comprise terephthalic acid units, and optionally isophthalic acid units; 100 to 2 mole % 2,2,4,4, tetramethyl-1,3 cyclobutanediol units (trans or cis or mixtures thereof); and from 0 to 98% 1,4 cyclohexanedimethanol units (trans or cis or mixtures thereof). For example, the polyester may comprise 100 mole % terephthalic acid units; 5 to 70 mol % 2,2,4,4, tetramethyl-1,3 cyclobutanediol (trans or cis or mixtures thereof); and 95 to 30 mole % cyclohexanedimethanol units (trans or cis or mixtures thereof).

In the present invention, addition of mineral fillers to polyesters containing 2,2,4,4-tetramethyl-1,3-cyclobutanediol (also described herein as TMCD) results in a formulation with unexpectedly good tensile elongation at break when compared, for example, with polycarbonates and with polyesters prepared without TMCD.

Surprisingly, it has been discovered that compositions of a polyester of terephthalic acid, 2,2,4,4, tetramethyl-1,3 cyclobutanediol (also described herein as TMCD), and optionally 1,4 cyclohexanedimethanol (also described herein as CHDM), with a mineral filler can be prepared which have a balance of good toughness, high modulus, and heat resistance. In this invention, the toughness is evidenced, for example, as the tensile elongation at break.

Normally, when the modulus of a polyester or polycarbonate is increased by blending with a mineral filler, the formulation will have much lower tensile break elongation than the neat polyester. The formulations of this invention, on the other hand, have tensile break elongations much closer to those of the neat polyester or polycarbonate.

Terephthalic acid may thus be present in the polyesters in an amount, for example, of at least 50 mole percent, or at least 75 mole percent, or at least 90 mole percent, or at least 95 mole percent, with the total amount of dicarboxylic acids present in the polyester comprising 100 mole percent. Isophthalic acid, if present, may be present in an amount, for example, up to 20 mole percent, or up to 10 mole percent, or up to 5 mole percent, or up to 2 mole percent. In one aspect, the amount of terephthalic acid present in the polyester may comprise 100 mole percent.

The polyesters of this invention are prepared from aromatic dicarboxylic acids or their esters or a mixture of aromatic dicarboxylic acids or their equivalent esters, 2 to 100 mole % 2,2,4,4, tetramethyl-1,3 cyclobutanediol (trans or cis or mixtures thereof), and 0 to 98% 1,4 cyclohexanedimethanol (trans or cis or mixtures thereof). Examples of esters of the dicarboxylic acids useful in this invention include the dimethyl, dipropyl, diisopropyl, dibutyl, diphenyl, etc.

The dicarboxylic acid portion of these polyesters may include, in addition to the terephthalic acid and the optional isophthalic acid, up to 20 mol %, but typically less than 10 mol % of other aromatic dicarboxylic acids. Examples of suitable aromatic dicarboxylic acids include 4,4′ biphenyldicarboxylic acid, 1,5-, 2,6-, 2,7-naphthalenedicarboxylic acid, 4,4′-oxydibenzoic acid or trans-4,4′-stilbenedicarboxylic acids. In addition the dicarboxylic acid portion of the polyesters may be substituted with aliphatic or cycloaliphatic dicarboxylic acids containing 6 to 12 carbon atoms such as succinic, glutaric, adipic, sebacic, suberic, azelaic, decanedicarboxylic, or dodecanedicarboxylic acids.

2,2,4,4, tetramethyl-1,3 cyclobutanediol (trans or cis or mixtures thereof) may be present in the polyesters of the invention in an amount, for example, of from 2 mole percent to 100 mole percent, or from 5 mole percent to 40 mole percent, or from 10 mole percent to 35 mole percent, in each case with the total amount of glycols comprising 100 mole percent. In other aspects, the TMCD may be present in an amount of at least 5 wt. %, or at least 10 wt. %, or at least 15 wt. %, up to about 40 wt. %, or up to 50 wt. %, or up to 60 wt. %, or up to 75 wt. %.

1,4-cyclohexanedimethanol (trans or cis or mixtures thereof) is typically present in the polyesters of the invention in an amount, for example, of at least 5 mole percent, or at least 10 mole percent, or at least 25 mole percent, up to, for example, about 50 mole percent, or up to 60 mole percent, or up to 75 mole percent, or up to 95 mole percent, in each case with the total amount of glycols comprising 100 mole percent.

In addition to the TMCD and the CHDM, the glycol portion of these aliphatic-aromatic polyesters may contain up to 20 mol % or more, but typically less than 10 mol % of another glycol containing 2 to 16 carbon atoms. Examples of suitable glycols include ethylene glycol, 1,2-propanediol, 1,3-propanediol, neopentyl glycol, 1,4-butanediol, 1,5-pentanediol, 1,6-hexanediol, or p-xylene glycol. The polymers may also be modified with polyethylene glycols or polytetramethylene glycols. Examples of esters of the dicarboxylic acids useful in this invention include the dimethyl, dipropyl, diisopropyl, dibutyl, diphenyl etc.

The mineral filler component of this invention may be selected from minerals used to reinforce plastics, including those of platelet (flake), acicular (needle), fibrous, cube, block, and spherical or irregular particle types. Nanoparticles such as those derived from layered silicates, for example montmorillonite clays, are likewise suitable for use according to the invention. We have found that the improvement in tensile elongation in break is exhibited in a wide range of types of mineral fillers, and that untreated talc, untreated calcium carbonate, and wollastonite, for example, are all well-suited for use according to the invention, as demonstrated in the examples.

Talc is a mineral filler that is useful according to the invention, and may be in the form of flakes or plates, for example as platy talc, and may have a wide range of particle sizes, for example from 0.5 microns to 100 microns esd, or at least 1 micron, or at least 2 micron, or at least 5 micron, and up to 100 microns, or up to 75 microns, or up to 50 microns, or up to 20 microns, esd.

Wollastonite is likewise useful according to the invention as a mineral filler, and may be in acicular form characterized by a relatively high aspect ratio, for example from 12:1 to 20:1, or ground for example into powder grade form having an aspect ratio, for example, of from 3:1 to 5:1. Thus, the aspect ratio of wollastonites useful according to the invention may be from about 3:1 to about 20:1, or from 5:1 to 15:1, or from 6:1 to 12:1. Wollastonite is available in a range of particle sizes, and may be used, for example, in the form of particles having an esd from 0.5 to 100 microns, or at least 1 micron, or at least 2 micron, or at least 5 micron, and up to 100 microns, or up to 75 microns, or up to 50 microns, or up to 20 microns, esd, and may be treated, for example with silanes, to improve compatibility with the polyesters with which it is blended.

Mica is useful according to the invention as a mineral filler, and is typically provided as sheets, plates, or flakes which may be ground to provide a wide range of particle sizes.

Calcium carbonate is useful according to the invention as a mineral filler, and may be provided as ground natural carbonate or as precipitated carbonate. The calcium carbonate may be provided as rhombohedral or prismatic particles, or in acicular aragonitic form. The ground calcium carbonate may have a wide range of particle sizes, for example from 200 mesh to 325 mesh, or as fine ground particles ranging from about 3 to 12 microns esd, or at least 1 micron, or at least 2 micron, or at least 5 micron, and up to 100 microns, or up to 75 microns, or up to 50 microns, or up to 20 microns, esd, or as ultrafine ground particles ranging from 500 to 2000 nm, or in median particle sizes ranging from 200 nm to 10 microns in size, or at least 1 nm, or at least 5 nm, or at least 50 nm, and up to 10 microns, or up to 5 microns, or up to 1 microns, or up to 0.5 microns, esd. Precipitated calcium carbonate may be used in median particle sizes, for example, from 70 to 700 nm, or from 100 to 500 nm, and both ground and precipitated calcium carbonate may be provided with stearate surface treatments to improve compatibility with the polyesters.

Kaolin clay is a mineral filler useful according to the invention, and is available in a number of grades: dry-ground kaolin of irregular form, water-washed clay, delaminated clay in plate form, and calcined clay of irregular form. Kaolin clay may thus be in the form of irregular spheres, plates, or amorphous, and may be surface treated, for example with stearates or silanes, to improve compatibility with the polyesters with which it is blended.

Feldspar and nepheline syenite are likewise useful according to the invention as mineral fillers, and may be provided milled in blocky irregular shapes having a wide range of esd particle sizes.

Silica is also useful according to the invention as a mineral filler, and may be in crystalline form, for example as ground silica of irregular shape, or as novaculite milled into platelet form. Alternatively, the silica may be provided as amorphous or precipitated silica, for example prepared from the reaction of sodium silicate with an acid, and may be available in particle sizes as small 10-30 nm, or as agglomerates.

Amorphous or crystalline aluminum silicates are also useful according to the invention as mineral fillers, as are calcium metasilicate, metallic oxides, and silicon carbide, and may be provided in a wide range of particle sizes.

Silicates, such as layered silicates, are likewise useful according to the invention, for example those obtained from montmorillonite clays. These layered silicates may be provided as nanoparticles, for example having an esd from about 0.5 nm to about 2 microns, or from 1 nm to 1 micron, or from 5 nm to 750 nm.

Sulfates such as barium sulfate are also useful according to the invention as a mineral filler, and may be provided as barite, for example of 325 mesh or finer, or as blanc fixe, which is precipitated barium sulfate useful especially where smaller particle size or higher brightness is desired.

Sulfides such as zinc sulfide, are also useful according to the invention as mineral fillers, as are titanates such as barium titanate. Further mineral fillers useful according to the invention include diatomite, pyrophyllite.

In addition, two or more of these mineral fillers may be added in combination. For example, small spheres may be combined with particles having a higher aspect ratio in order to improve stress properties.

The mineral fillers of the invention may be employed as described above, or in a finely divided form, and the median particle diameter may vary over a wide range, for instance from about 0.01 to about 1,000 microns, or, for example, less than 50 microns. The mineral fillers may likewise be in the form of nanoparticles, for example having an esd from about 0.5 nm to about 2 microns, or from 1 nm to 1 micron, or from 5 nm to 750 nm.

The mineral filler may be untreated or may contain some type of surface modification. Surface modifications include those intended to improve stress transfer, matrix wetting, and matrix adhesion, for example by bonding to the polymer in which they are blended. Examples of surface modifications include silane treatment of wollastonite, addition of stearic acid to calcium carbonate, and the addition of coupling agents.

The compositions of this invention are prepared by any conventional mixing methods. For example, a preferred method comprises mixing the polyester in powder or granular form with the mineral filler in an extruder and extruding the mixture into strands, chopping the strands into pellets and molding the pellets into the desired article.

The term “polyester”, as used herein, refers to any unit-type of polyester falling within the scope of the polyester portion of the present blend, including but not limited to copolyesters and terpolyesters. The polyester may thus comprise a dicarboxylic acid component of typically about 70 to 100 mole percent TPA and/or isophthalic acid (IPA) units, and 0 to about 20 mole percent modifying dicarboxylic acid units, and a glycol component of, for example, from about 2 to about 100 mole percent TMCD units, and optionally from 0 mole percent to 98 mole percent CHDM (trans or cis or mixtures thereof), with minor amounts of modifying glycol units, wherein the total dicarboxylic acid units is equal to 100 mole percent, the total glycol units is equal to 100 mole percent, with the total polyester units equal to 200 mole percent.

Terephthalic acid (TPA) and isophthalic acid (IPA) are the preferred primary dicarboxylic acids for providing a polyester. A higher concentration of TPA in the polyester than IPA is preferred because TPA produces a polyester that provides greater impact strength to the composition. Therefore, it is preferred that the dicarboxylic acid component of the polyester be 50 to 100 mole percent TPA and 0 to 50 mole percent IPA, more preferably 70 to 100 mole percent TPA and 0 to 30 mole percent IPA, with at least 90 mole percent, or at least 95 mole percent, up to 100 mole percent terephthalic acid.

In addition to TPA and IPA, the dicarboxylic acid component of the polyester can be substituted with up to 20 mole percent, but preferably less than 10 mole percent of other modifying dicarboxylic acids having 2 to 20 carbon atoms. Suitable examples of modifying aromatic dicarboxylic acids include 4,4′-biphenyldicarboxylic acid, 1,4-, 1,5-, 2,6-, 2,7-naphthalenedicarboxylic acid, 4,4′-oxybenzoic, trans-4,4′-stilbenedicarboxylic acid, or mixtures thereof. Suitable examples of modifying aliphatic dicarboxylic acids are those containing 2 to 12 carbon atoms, such as oxalic, malonic, succinic, glutaric, adipic, pimelic, suberic, azelaic, and sebacic acids, or mixtures thereof.

It is important to note that the dicarboxylic acid component of the polyester portion of the present blend may be prepared from dicarboxylic acids, their corresponding esters, or mixtures thereof. Examples of esters of the dicarboxylic acids useful in the present invention include the dimethyl, dipropyl, diisopropyl, dibutyl, and diphenyl esters, and the like.

In one embodiment, terephthalic acid may be used as the starting material to prepare the polyesters of the blends of the invention. In another embodiment, dimethyl terephthalate may be used as the starting material. In yet another embodiment, mixtures of terephthalic acid and dimethyl terephthalate may be used as the starting material and/or as an intermediate material.

The polyester portion of this invention may thus comprise TPA and optionally IPA units, from 100 to 2 mole percent TMCD units (trans or cis or mixtures thereof), and 0 to 98 mole percent CHDM units (trans or cis or mixtures thereof). A specific range of the compositions of the polyester may comprise 100 mole percent TPA units, 15 to 35 mole percent TMCD (trans or cis or mixtures thereof), and 65 to 85 mole percent cyclohexanedimethanol units (trans or cis or mixtures thereof). Although the polyesters may typically comprise amounts of TMCD and CHDM that total 100 mole percent, this is not required, and as disclosed herein, there may be only TMCD, or TMCD and CHDM combined together, or TMCD and CHDM used together with one or more additional glycols. In some embodiments, however, the amount of CHDM may be selected such that, when combined with a given amount of TMCD, together constitute 100 mole percent.

The glycol component of the polyester portion of the present blend is thus formed from 2 to 100 mole percent of TMCD units, or from 10 to 85 mole percent TMCD units, or from 15 to 75 mole percent TMCD units, or from 20 to 50 mole percent TMCD units, or from 25 to 35 mole percent TMCD units. The glycol component of the polyester portion of the present blend further comprises from 0 mole percent to 95 mole percent CHDM units, or from 10 to 90 mole percent CHDM units, or from 20 to 60 mole percent CHDM units.

In various embodiments, the amount of TMCD may thus be at least 2 mole percent, or at least 5 mole percent, or at least 10 mole percent, or at least 15 mole percent, up to about 40 mole percent, or up to about 50 mole percent, or up to 75 mole percent, or up to 90 mole percent, or up to 100 mole percent.

Similarly, the amount of CHDM, if present, may be at least 2 mole percent, or at least 5 mole percent, or at least 10 mole percent, or at least 20 mole percent, up to about 50 mole percent, or up to 60 mole percent, or up to 75 mole percent, or up to 90 mole percent, or up to 98 mole percent.

The 2,2,4,4-tetramethyl-1,3-cyclobutanediol (TMCD) can be cis, trans, or a mixture thereof, for example from 45-55 mole percent trans, where the total of cis and trans isomer content is equal to 100 mole percent, or alternatively, about a 50/50 trans/cis ratio.

In other aspects of the invention, the glycol component for the polyesters useful in the invention include but are not limited to at least one of the following combinations of ranges: 5 to 100 mole percent 2,2,4,4-tetramethyl-1,3-cyclobutanediol and 0 to 95 mole percent 1,4-cyclohexanedimethanol; 10 to 90 mole percent 2,2,4,4-tetramethyl-1,3-cyclobutanediol and 10 to 90 mole percent 1,4-cyclohexanedimethanol; or 20 to 75 mole percent 2,2,4,4-tetramethyl-1,3-cyclobutanediol and 25 to 80 mole percent 1,4-cyclohexanedimethanol; or 25 to 50 mole percent 2,2,4,4-tetramethyl-1,3-cyclobutanediol and 50 to 75 mole percent 1,4-cyclohexanedimethanol.

The 1,4-cyclohexanedimethanol may be cis, trans, or a mixture thereof, for example, a cis/trans ratio of 60:40 to 40:60. In another embodiment, the trans-1,4-cyclohexanedimethanol can be present in an amount of 60 to 80 mole percent.

Modifying glycols useful in the polyesters useful in the invention refer to diols other than 2,2,4,4-tetramethyl-1,3-cyclobutanediol and 1,4-cyclohexane-dimethanol and can contain 2 to 16 carbon atoms. Examples of suitable modifying glycols include, but are not limited to, ethylene glycol, 1,2-propanediol, 1,3-propanediol, neopentyl glycol, 1,4-butanediol, 1,5-pentanediol, 1,6-hexanediol, p-xylene glycol, or mixtures thereof. In one embodiment, the modifying glycol is ethylene glycol. In another embodiment, the modifying glycols include, but are not limited to 1,3-propanediol and 1,4-butanediol. In another embodiment, ethylene glycol is excluded as a modifying diol. In another embodiment, 1,3-propanediol and 1,4-butanediol are excluded as modifying diols. In another embodiment, 2,2-dimethyl-1,3-propanediol is excluded as a modifying diol.

The glycol component can also be modified with 0 to about 10 mole percent polyethylene glycol or polytetramethylene glycol to enhance elastomeric behavior.

The polyesters useful in the polyester compositions of the invention can comprise from 0 to 10 mole percent, for example, from 0.01 to 5 mole percent, from 0.01 to 1 mole percent, from 0.05 to 5 mole percent, from 0.05 to 1 mole percent or from 0.1 to 0.7 mole percent, based on the total mole percent ages of either the diol or diacid residues, respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. The polyester(s) useful in the invention can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

The polyesters of the invention can comprise at least one chain extender. Suitable chain extenders include, but are not limited to, multifunctional (including, but not limited to, bifunctional) isocyanates, multifunctional epoxides, including for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 percent by weight to about 10 percent by weight, such as about 0.1 to about 5 percent by weight, based on the total weight of the polyester.

Thermal stabilizers are compounds that stabilize polyesters during polyester manufacture and/or post polymerization, including but not limited to phosphorous compounds including but not limited to phosphoric acid, phosphorous acid, phosphonic acid, phosphinic acid, phosphonous acid, and various esters and salts thereof. These can be present in the polyester compositions useful in the invention. The esters can be alkyl, branched alkyl, substituted alkyl, difunctional alkyl, alkyl ethers, aryl, and substituted aryl. In one embodiment, the number of ester groups present in the particular phosphorous compound can vary from zero up to the maximum allowable based on the number of hydroxyl groups present on the thermal stabilizer used. The term “thermal stabilizer” is intended to include the reaction product(s) thereof. The term “reaction product” as used in connection with the thermal stabilizers of the invention refers to any product of a polycondensation or esterification reaction between the thermal stabilizer and any of the monomers used in making the polyester as well as the product of a polycondensation or esterification reaction between the catalyst and any other type of additive.

In some embodiments, use of the polyester compositions useful in the invention minimizes and/or eliminates the drying step prior to melt processing and/or thermoforming.

The polyester portion of the polyester compositions useful in the invention can be made by processes known from the literature such as, for example, by processes in homogenous solution, by transesterification processes in the melt, and by two phase interfacial processes. Suitable methods include, but are not limited to, the steps of reacting one or more dicarboxylic acids with one or more glycols at a temperature of 100° C. to 315° C. at a pressure of 0.1 to 760 mm Hg for a time sufficient to form a polyester. See U.S. Pat. No. 3,772,405 for methods of producing polyesters, the disclosure regarding such methods is hereby incorporated herein by reference.

In another aspect, the invention relates to compositions that comprise a mineral filler and a polyester produced by a process comprising:

(I) heating a mixture comprising the monomers in the presence of a catalyst at a temperature of 150 to 240° C. for a time sufficient to produce an initial polyester;

(II) heating the initial polyester of step (I) at a temperature of 240 to 320° C. for 1 to 4 hours; and

(III) removing any unreacted glycols.

Suitable catalysts for use in this process include, but are not limited to, organo-zinc or tin compounds. The use of this type of catalyst is well known in the art. Examples of catalysts useful in the present invention include, but are not limited to, zinc acetate, butyltin tris-2-ethylhexanoate, dibutyltin diacetate, and dibutyltin oxide. Other catalysts may include, but are not limited to, those based on titanium, zinc, manganese, lithium, germanium, and cobalt. Catalyst amounts can range from 10 ppm to 20,000 ppm or 10 to 10,000 ppm, or 10 to 5000 ppm or 10 to 1000 ppm or 10 to 500 ppm, or 10 to 300 ppm or 10 to 250 based on the catalyst metal and based on the weight of the final polymer. The process can be carried out in either a batch or continuous process.

Typically, step (I) can be carried out until 50 percent by weight or more of the 2,2,4,4-tetramethyl-1,3-cyclobutanediol has been reacted. Step (I) may be carried out under pressure, ranging from atmospheric pressure to 100 psig. The term “reaction product” as used in connection with any of the catalysts useful in the invention refers to any product of a polycondensation or esterification reaction with the catalyst and any of the monomers used in making the polyester as well as the product of a polycondensation or esterification reaction between the catalyst and any other type of additive.

Typically, Step (II) and Step (III) can be conducted at the same time. These steps can be carried out by methods known in the art such as by placing the reaction mixture under a pressure ranging, from 0.002 psig to below atmospheric pressure, or by blowing hot nitrogen gas over the mixture.

The reinforced polyester compositions may further comprise minor amounts, for example less than 20 wt. %, or less than 10 wt. %, or less than 5 wt. %, of “polycarbonates,” such as the condensation product of a carbonate source and a diol source, having a carbonate component containing 100 mole percent carbonate units and a diol component containing 100 mole percent diol units, for a total of 200 mole percent monomeric units. The term “diol” as used herein, includes both aliphatic and aromatic compounds having two hydroxyl groups.

The polycarbonate portion of the blend may be based upon the polycarbonate of 4,4′-isopropylidenediphenol, commonly known as bisphenol A. Suitable examples of commercially available bisphenol A polycarbonate include LEXAN and MAKROLON.

It should, of course be clear that other additives may be included in the present compositions. These additives include additional fillers, plasticizers, pigments, flame retardant additives, reinforcing agents such as glass fibers, stabilizers, processing aids, impact modifiers, etc.

The term “container” as used herein is understood to mean a receptacle in which material is held or stored. “Containers” include but are not limited to bottles, bags, vials, tubes and jars. Applications in the industry for these types of containers include but are not limited to food, beverage, cosmetics and personal care applications.

The term “bottle” as used herein is understood to mean a receptacle containing plastic which is capable of storing or holding liquid.

The term “molded article” is intended to include any article made in a mold that takes on the shape of the mold in which it is formed, including without limitation a bottle, tray, or bottle preform, but is not intended to include films which are simply passed through a dye, for example.

In addition, the polyester compositions of the invention may also contain from 0.01 to 25 percent by weight of the overall composition common additives such as colorants, dyes, mold release agents, flame retardants, plasticizers, nucleating agents, stabilizers, including but not limited to, UV stabilizers, thermal stabilizers and/or reaction products thereof, additional fillers, and impact modifiers. Examples of typical commercially available impact modifiers well known in the art and useful in this invention include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

The invention further relates to containers described herein. The methods of forming the polymer blends into containers are well known in the art.

The invention further relates to bottles described herein. The methods of forming the polymer blends into bottles are well known in the art. Examples of bottles include but are not limited to bottles such as baby bottles; water bottles; juice bottles; large commercial water bottles having a weight from 200 to 800 grams; beverage bottles which include but are not limited to two liter bottles, 20 ounce bottles, 16.9 ounce bottles; medical bottles; personal care bottles, carbonated soft drink bottles; hot fill bottles; water bottles; alcoholic beverage bottles such as beer bottles and wine bottles; and bottles comprising at least one handle. These bottles include but are not limited to injection blow molded bottles, injection stretch blow molded bottles, extrusion blow molded bottles, and extrusion stretch blow molded bottles. Methods of making bottles include but are not limited to extrusion blow molding, extrusion stretch blow molding, injection blow molding, and injection stretch blow molding. In each case, the invention further relates to the preforms (or parisons) used to make each of said bottles.

These bottles include, but are not limited to, injection blow molded bottles, injection stretch blow molded bottles, extrusion blow molded bottles, and extrusion stretch blow molded bottles. Methods of making bottles include but are not limited to extrusion blow molding, extrusion stretch blow molding, thermoforming, injection blow molding, and injection stretch blow molding.

Other examples of containers include, but are not limited to, containers for cosmetics and personal care applications including bottles, jars, vials and tubes; sterilization containers; buffet steam pans; food pans or trays; frozen food trays; microwaveable food trays; hot fill containers; food storage containers; for example, boxes; tumblers, pitchers, cups, bowls, including but not limited to those used in restaurant smallware; beverage containers; retort food containers; centrifuge bowls; vacuum cleaner canisters, and collection and treatment canisters.

For the purposes of this invention, the term “wt” means “weight”.

The following examples further illustrate the invention and are intended to be purely exemplary of the invention and are not intended to limit the scope thereof. Unless indicated otherwise, parts are parts by weight, temperature is in degrees C. or is at room temperature, and pressure is at or near atmospheric.

### EXAMPLES

### Measurement Methods

The inherent viscosity of the polyesters was determined in 60/40 (wt/wt) phenol/tetrachloroethane at a concentration of 0.5 g/100 ml at 25° C. The glass transition temperatures were determined using a TA Instruments differential scanning calorimeter (DSC) at a scan rate of 20° C. The composition of the neat resins was determined by proton nuclear magnetic resonance spectroscopy (NMR).

### Example 1

The aliphatic-aromatic polyester (Polyester A) used contained terephthalic acid, 23.0 mol % 2,2,4,4, tetramethyl-1,3 cyclobutanediol and, 77.0 mol % cyclohexanedimethanol. The inherent viscosity was measured to be 0.72. The mineral filler used was an untreated talc with an average particle size of 7 microns.

The aliphatic-aromatic polyester was dried at 90° C. and the talc was not dried. Formulations were prepared in a 40 mm Werner-Pflieder twin screw extruder. The polyester and talc were fed into the extruder by separate gravimetric feeders and the extruded strand was pelletized. The pellets were injection molded into parts on a Toyo 90 injection molding machine. The extruder was run at 300 rpm at a total feed rate of 180 pounds/hr. Processing temperatures used were in the range of 260° C. to 280° C. The compositions and properties of the blends are shown in Table 1. The weight percent of talc was calculated by measuring the weight percent ash level in the sample. It is felt that this measured percentage is a more accurate measure of the talc content than the target level based on the feeder settings. The sample containing no filler was not extruded; typical properties after injection molding are shown for it.

Heat deflection temperature, at 264 psi, was determined according to ASTM D648. Flexural modulus and flexural strength were determined according to ASTM D790. Tensile properties were determined according to ASTM D638.

TABLE 1

| | UNITS | | | | |
|---|---|---|---|---|---|
| % Aliphatic-aromatic | % | 100 | 95.6 | 91.8 | 84.9 |
| polyester A | | | | | |
| % Talc (calculated from | % | 0 | 4.4 | 8.2 | 15.1 |
| % ash) | | | | | |
| Heat Deflection | (deg C.) | 85 | 83 | 84 | 87 |
| Temperature 264 Psi | | | | | |
| Tensile Strength | MPa | 53 | 44 | 46 | 48 |
| Tensile Break Elongation | % | 210 | 163 | 151 | 108 |
| % Retained Break | | | 77.6 | 71.9 | 51.4 |
| Elongation | | | | | |
| Flexural Modulus | MPa | 1550 | 1792 | 2050 | 2565 |
| Flexural Strength | MPa | 62 | 66 | 69 | 73 |

### Example 2

The aliphatic-aromatic polyester (Polyester B) used contained terephthalic acid, 33.9 mol % 2,2,4,4, tetramethyl-1,3 cyclobutanediol and, 66.1 mol % cyclohexanedimethanol. The inherent viscosity was measured to be 0.66. The mineral filler used was an untreated talc with an average particle size of 7 microns.

The aliphatic-aromatic polyester was dried at 90° C. and the talc was not dried. Formulations were prepared in a 40 mm Werner-Pflieder twin screw extruder. The polyester and talc were fed into the extruder by separate gravimeteric feeders and the extruded strand was pelletized. The pellets were injection molded into parts on a Toyo 90 injection molding machine. The extruder was run at 300 rpm at a total feed rate of 180 pounds/hr. Processing temperatures used were in the range of 260° C. to 280° C. The compositions and properties of the blends are shown in Table 2. The weight percent of talc was calculated by measuring the weight percent ash level in the sample. The sample containing no filler was not extruded; typical properties after injection molding are shown for it.

TABLE 2

| | UNITS | | | | | |
|---|---|---|---|---|---|---|
| % Aliphatic-aromatic polyester B | % | 100 | 94.3 | 90.8 | 85.5 | 82.1 |
| % Talc (calculated from % ash) | % | 0 | 5.7 | 9.2 | 14.5 | 17.9 |
| Heat Deflection Temperature 264 Psi | (deg C.) | 92 | 91 | 93 | 96 | 96 |
| Tensile Strength | MPa | 53 | 47 | 48 | 49 | 50 |
| Tensile Break Elongation | % | 140 | 131 | 124 | 70 | 40 |
| % Retained Break Elongation | | | 93.6 | 88.6 | 49.9 | 28.3 |
| Flexural Modulus | MPa | 1585 | 1885 | 2040 | 2440 | 2666 |
| Flexural Strength | MPa | 66 | 70 | 72 | 74 | 77 |

### Example 3

The aliphatic-aromatic polyester (Polyester A) used contained terephthalic acid, 23.0 mol % 2,2,4,4, tetramethyl-1,3 cyclobutanediol and, 77.0 mol % cyclohexanedimethanol. The inherent viscosity was measured to be 0.72. The mineral filler used was an untreated calcium carbonate with an average particle size of 1 micron.

The aliphatic-aromatic polyester was dried at 90° C. and the calcium carbonate was not dried. Formulations were prepared in a 40 mm Werner-Pflieder twin screw extruder. The polyester and calcium carbonate were fed into the extruder by separate gravimetric feeders and the extruded strand was pelletized. The pellets were injection molded into parts on a Toyo 90 injection molding machine. The extruder was run at 300 rpm at a total feed rate of 180 pounds/hr. Processing temperatures used were in the range of 260° C. to 280° C. The compositions and properties of the blends are shown in Table 3. The weight percent of calcium carbonate was calculated by measuring the weight percent ash level in the sample. The sample containing no filler was not extruded; typical properties after injection molding are shown for it.

TABLE 3

| | UNITS | | | | | |
|---|---|---|---|---|---|---|
| % Aliphatic-aromatic polyester A | % | 100 | 95.7 | 91.8 | 84.9 | 79.1 |
| % Calcium carbonate (calculated from % ash) | % | 0 | 4.3 | 8.2 | 15.1 | 20.9 |
| Heat Deflection Temperature 264 Psi | (deg C.) | 85 | 81 | 81 | 82 | 84 |
| Tensile Strength | MPa | 53 | 44 | 44 | 45 | 46 |
| Tensile Break Elongation | % | 210 | 141 | 126 | 97 | 48 |
| % Retained Break Elongation | | | 67.1 | 60.0 | 46.2 | 22.9 |
| Flexural Modulus | MPa | 1550 | 1620 | 1702 | 1877 | 2123 |
| Flexural Strength | MPa | 62 | 64 | 65 | 66 | 68 |

### Example 4

The aliphatic-aromatic polyester (Polyester B) used contained terephthalic acid, 33.9 mol % 2,2,4,4, tetramethyl-1,3 cyclobutanediol, and 66.1 mol % cyclohexanedimethanol. The inherent viscosity was measured to be 0.66. The mineral filler used was an untreated calcium carbonate with an average particle size of 1 micron.

The aliphatic-aromatic polyester was dried at 90° C. and the calcium carbonate was not dried. Formulations were prepared in a 40 mm Werner-Pflieder twin screw extruder. The polyester and calcium carbonate were fed into the extruder by separate gravimetric feeders and the extruded strand was pelletized. The pellets were injection molded into parts on a Toyo 90 injection molding machine. The extruder was run at 300 rpm at a total feed rate of 180 pounds/hr. Processing temperatures used were in the range of 260° C. to 280° C. The compositions and properties of the blends are shown in Table 4. The weight percent of calcium carbonate was calculated by measuring the weight percent ash level in the sample. The sample containing no filler was not extruded; typical properties after injection molding are shown for it.

TABLE 4

| | UNITS | | | | | |
|---|---|---|---|---|---|---|
| % Aliphatic-aromatic polyester B | % | 100 | 95.8 | 91.8 | 81.9 | 72.6 |
| % Calcium carbonate (calculated from % ash) | % | 0 | 4.2 | 8.2 | 18.1 | 27.4 |
| Heat Deflection Temperature 264 Psi | (deg C.) | 92 | 92 | 91 | 93 | 95 |
| Tensile Strength | MPa | 53 | 46 | 46 | 48 | 49 |
| Tensile Break Elongation | % | 140 | 112 | 93 | 41 | 16 |
| % Retained Break Elongation | | | 80.0 | 66.4 | 29.3 | 11.4 |
| Flexural Modulus | MPa | 1585 | 1637 | 1703 | 1976 | 2308 |
| Flexural Strength | MPa | 66 | 68 | 69 | 71 | 75 |

### Counter Example 1

The aliphatic-aromatic polyester (Polyester C) used was EastarCopolyester 6763. It contained terephthalic acid and approximately 3 μmol % cyclohexanedimethanol and 69 mol % ethylene glycol. Its inherent viscosity was 0.73. The mineral filler used was an untreated talc with an average particle size of 7 microns.

The aliphatic-aromatic polyester was dried at 70° C. and the talc was not dried. Formulations were prepared in a 40 mm Werner-Pflieder twin screw extruder. The polyester and talc were fed into the extruder by separate gravimetric feeders and the extruded strand was pelletized. The pellets were injection molded into parts on a Toyo 90 injection molding machine. The extruder was run at 300 rpm at a total feed rate of 180 pounds/hr. Processing temperatures used were in the range of 260° C. to 280° C. The compositions and properties of the blends are shown in Table 5. The weight percent of talc was calculated by measuring the weight percent ash level in the sample. The sample containing no filler was not extruded; typical properties after injection molding are shown for it.

TABLE 5

| | UNITS | | | | | |
|---|---|---|---|---|---|---|
| % Aliphatic-aromatic polyester C | % | 100 | 92.4 | 88.4 | 79.4 | 75.7 |
| % Talc (calculated from % ash) | % | 0 | 4.4 | 7.9 | 13.3 | 17.1 |
| Heat Deflection Temperature 264 Psi | (deg C.) | 64 | 63 | 64 | 65 | 66 |
| Tensile Strength | MPa | 50 | 50 | 51 | 52 | 52 |
| Tensile Break Elongation | % | 130 | 25 | 20 | 11 | 8 |
| % Retained Break Elongation | | | 19.5 | 15.4 | 8.1 | 6.2 |
| Flexural Modulus | MPa | 2100 | 2371 | 2650 | 3135 | 3453 |
| Flexural Strength | MPa | 70 | 71 | 72 | 74 | 75 |

### Counter Example 2

The aliphatic-aromatic polyester (Polyester C) used was Eastar Copolyester 6763. It contained terephthalic acid and approximately 31 mol % cyclohexanedimethanol and 69 mol % ethylene glycol. Its inherent viscosity was 0.73. The mineral filler used was an untreated calcium carbonate with an average particle size of 1 micron.

The aliphatic-aromatic polyester was dried at 70° C. and the calcium carbonate was not dried. Formulations were prepared in a 40 mm Werner-Pflieder twin screw extruder. The polyester and calcium carbonate were fed into the extruder by separate gravimetric feeders and the extruded strand was pelletized. The pellets were injection molded into parts on a Toyo 90 injection molding machine. The extruder was run at 300 rpm at a total feed rate of 180 pounds/hr. Processing temperatures used were in the range of 260° C. to 280° C. The compositions and properties of the blends are shown in Table 6. The weight percent of calcium carbonate was calculated by measuring the weight percent ash level in the sample. The sample containing no filler was not extruded; typical properties after injection molding are shown for it.

TABLE 6

| | UNITS | | | | | | |
|---|---|---|---|---|---|---|---|
| % Aliphatic-aromatic polyester C | % | 100 | 89.1 | 85.9 | 79.7 | 76.0 | 69.5 |
| % Calcium carbonate (calculated from % ash) | % | 0 | 4.3 | 7.8 | 13.0 | 17.8 | 28.4 |
| Heat Deflection Temperature 264 Psi | (deg C.) | 64 | 62 | 63 | 63 | 63 | 65 |
| Tensile Strength | MPa | 50 | 49 | 50 | 50 | 51 | 51 |
| Tensile Break Elongation | % | 130 | 45 | 35 | 18 | 13 | 9 |
| % Retained Break Elongation | | | 34.7 | 26.6 | 13.8 | 10.3 | 6.9 |
| Flexural Modulus | MPa | 2100 | 2199 | 2314 | 2483 | 2694 | 3140 |
| Flexural Strength | MPa | 70 | 70 | 70 | 72 | 73 | 75 |

### Counter Example 3

The polyester used was the polycarbonate of 4,4′-isopropylidenediphenol (bisphenol A). The mineral filler used was an untreated talc with an average particle size of 7 microns.

The polycarbonate polyester was dried at 90° C. and the talc was not dried. Formulations were prepared in a 40 mm Werner-Pflieder twin screw extruder. The polyester and talc were fed into the extruder by separate gravimetric feeders and the extruded strand was pelletized. The pellets were injection molded into parts on a Toyo 90 injection molding machine. The extruder was run at 300 rpm at a total feed rate of 180 pounds/hr. Processing temperatures used were in the range of 270° C. to 290° C. The compositions and properties of the blends are shown in Table 7. The weight percent of talc was calculated by measuring the weight percent ash level in the sample. The sample containing no filler was not extruded; typical properties after injection molding are shown for it.

TABLE 7

| | UNITS | | | | | |
|---|---|---|---|---|---|---|
| % Polycarbonate polyester | % | 100 | 95.9 | 92.1 | 85.6 | 80.4 |
| % Talc (calculated from % ash) | % | 0 | 4.1 | 7.9 | 14.4 | 19.6 |
| Heat Deflection Temperature 264 Psi | (deg C.) | 128 | 122 | 124 | 125 | 121 |
| Tensile Strength | MPa | 71 | 63 | 64 | 64 | 61 |
| Tensile Break Elongation | % | 132 | 88 | 39 | 8 | 4 |
| % Retained Break Elongation | | | 66.7 | 29.5 | 6.1 | 3.0 |
| Flexural Modulus | MPa | 2386 | 2714 | 2977 | 3632 | 4321 |
| Flexural Strength | MPa | 98 | 99 | 100 | 103 | * |

* Sample did not yield

### Counter Example 4

The polyester used was the polycarbonate of 4,4′-isopropylidenediphenol (bisphenol A). The mineral filler used was an untreated calcium carbonate with an average particle size of 1 micron.

The polycarbonate polyester was dried at 90° C. and the calcium carbonate was not dried. Formulations were prepared in a 40 mm Werner-Pflieder twin screw extruder. The polyester and calcium carbonate were fed into the extruder by separate gravimetric feeders and the extruded strand was pelletized. The pellets were injection molded into parts on a Toyo 90 injection molding machine. The extruder was run at 300 rpm at a total feed rate of 180 pounds/hr. Processing temperatures used were in the range of 270° C. to 290° C. The compositions and properties of the blends are shown in Table 8. The weight percent of calcium carbonate was calculated by measuring the weight percent ash level in the sample. The sample containing no filler was not extruded; typical properties after injection molding are shown for it.

TABLE 8

| | UNITS | | | | | |
|---|---|---|---|---|---|---|
| % Polycarbonate polyester | % | 100 | 91.7 | 86.8 | 76.1 | 72.2 |
| % Calcium carbonate (calculated from % ash) | % | 0 | 8.3 | 13.2 | 23.9* | 27.8* |
| Heat Deflection Temperature 264 Psi | (deg C.) | 128 | 125 | 125 | | |
| Tensile Strength | MPa | 71 | 64 | 65 | | |
| Tensile Break Elongation | % | 132 | 31 | 16 | | |
| % Retained Break Elongation | | | 23.5 | 12.1 | | |
| Flexural Modulus | MPa | 2386 | 2425 | 2536 | | |
| Flexural Strength | MPa | 98 | 97 | 98 | | |

*Samples too brittle to mold.

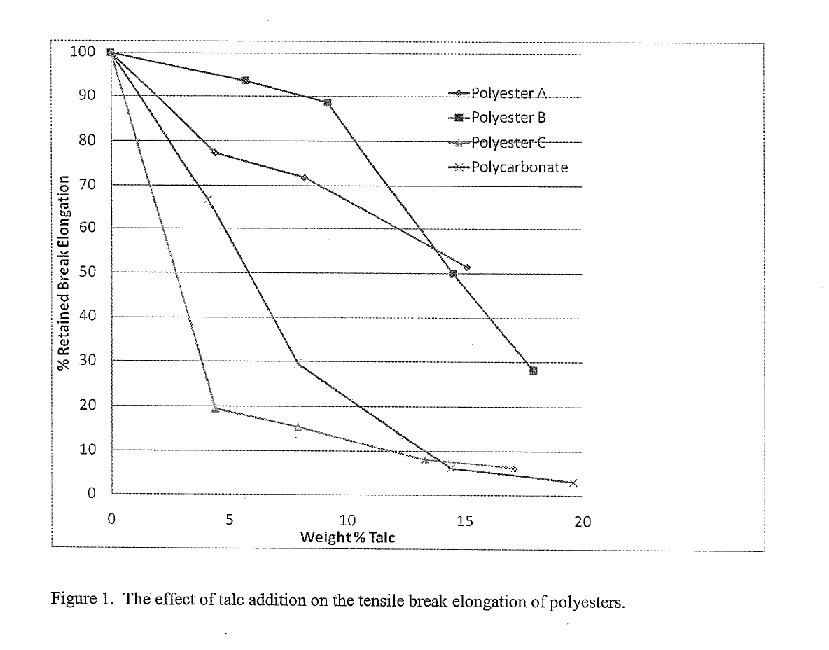

To better illustrate the effect of talc addition on the polyesters in the above examples, the % retained tensile break elongation is plotted as a function of talc level in FIG. 1. For polyester C and polycarbonate, the two polyesters used as comparative examples, addition of even low levels of talc (less than 10 weight percent) results in retained tensile break elongations of less than 30%. In contrast, for Polyesters A and B, which are used as examples for this invention, the retained tensile break elongation is greater than 70% at comparable talc levels. For higher levels of talc addition, significantly higher retained break elongations are also seen for Polyesters A and B as compared to Polyester C and polycarbonate.

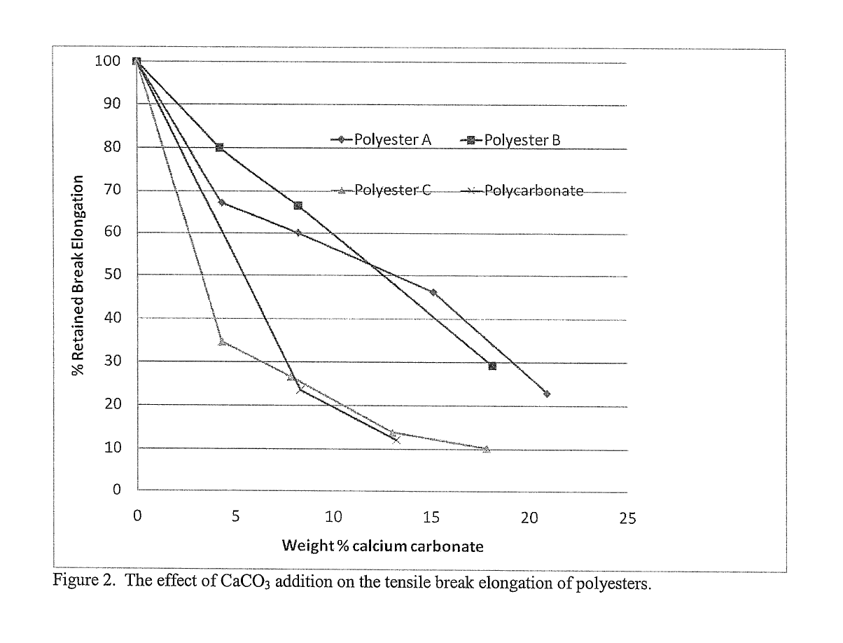

A similar effect is observed when calcium carbonate is used as the mineral filler. In FIG. 2 the percent retained tensile break elongation is plotted as a function of CaCO₃ percentage. The addition of approximately 10% CaCO₃ to Polyesters A and B of this invention results in retained tensile break elongations of at least 60%. In contrast, addition of comparable levels of CaCO3 yields a retained tensile break elongation of less than 30% for Polyester C and polycarbonate. A similar trend is seen at higher CaCO₃ levels.

### Example 5

The aliphatic-aromatic polyester (Polyester A) used contained terephthalic acid, 23.0 mol % 2,2,4,4, tetramethyl-1,3 cyclobutanediol and, 77.0 mol % cyclohexanedimethanol. The inherent viscosity was measured to be 0.72. The mineral filler used was NYGLOS 4W a wollastonite with a median particle size of 4.5 microns and an aspect ratio of 11:1, available from Nyco Minerals, Inc., Willsboro, New York.

The aliphatic-aromatic polyester was dried at 90° C. and the wollastonite was not dried. Formulations were prepared in a 30 mm Werner-Pflieder twin screw extruder. The polyester and wollastonite were fed into the extruder by separate gravimetric feeders and the extruded strand was pelletized. The pellets were injection molded into parts on a Toyo 90 injection molding machine. The extruder was run at 350 rpms at a feed rate to give a machine torque between 80-100%. Processing temperatures used were in the range of 260° C. to 280° C. The compositions and properties of the blends are shown in Table 9. The weight percent of wollastonite was calculated from the gravimetric settings used on the feeders. The sample containing no filler was not extruded; typical properties after injection molding are shown for it.

TABLE 9

| | UNITS | | | | | |
|---|---|---|---|---|---|---|
| % Aliphatic-aromatic polyester A | % | 100 | 95 | 90 | 85 | 80 |
| % NYGLOS 4W | % | 0 | 5 | 10 | 15 | 20 |
| Heat Deflection Temperature 264 Psi | (deg C.) | 85 | 82 | 85 | 86 | 86 |
| Tensile Strength | MPa | 53 | 51 | 49 | 47 | 48 |
| Tensile Break Elongation | % | 210 | 166 | 140 | 118 | 86 |
| % Retained Break Elongation | | | 79.0 | 66.7 | 56.2 | 41.0 |
| Flexural Modulus | MPa | 1550 | 1616 | 1743 | 1993 | 2221 |
| Flexural Strength | MPa | 62 | 63 | 64 | 67 | 70 |

### Example 6

The aliphatic-aromatic polyester (Polyester B) used contained terephthalic acid, 33.9 mol % 2,2,4,4, tetramethyl-1,3 cyclobutanediol, and 66.1 mol % cyclohexanedimethanol. The inherent viscosity was measured to be 0.66. The mineral filler used was NYGLOS 4W, a wollastonite with a median particle size of 4.5 microns, and an aspect ratio of 11:1, available from Nyco Minerals, Inc., Willsboro, N. Y.

The aliphatic-aromatic polyester was dried at 90° C. and the wollastonite was not dried. Formulations were prepared in a 30 mm Werner-Pflieder twin screw extruder. The polyester and the wollastonite were fed into the extruder by separate gravimetric feeders and the extruded strand was pelletized. The pellets were injection molded into parts on a Toyo 90 injection molding machine. The extruder was run at 350 rpms at a feed rate to give a machine torque between 80-100%. Processing temperatures used were in the range of 260° C. to 280° C. The compositions and properties of the blends are shown in Table 10. The weight percent of wollastonite was calculated from the gravimetric settings used on the feeders. The sample containing no filler was not extruded; typical properties after injection molding are shown for it.

TABLE 10

| | UNITS | | | | | |
|---|---|---|---|---|---|---|
| % Aliphatic-aromatic polyester B | % | 100 | 95 | 90 | 85 | 80 |
| % NYGLOS 4W | % | 0 | 5 | 10 | 15 | 20 |
| Heat Deflection Temperature 264 Psi | (deg C.) | 92 | 91 | 91 | 94 | 95 |
| Tensile Strength | MPa | 53 | 46 | 48 | 49 | 51 |
| Tensile Break Elongation | % | 140 | 125 | 90 | 73 | 48 |
| % Retained Break Elongation | | | 89.3 | 64.3 | 52.1 | 34.3 |
| Flexural Modulus | MPa | 1585 | 1671 | 1783 | 2038 | 2288 |
| Flexural Strength | MPa | 66 | 67 | 68 | 70 | 73 |

### Counter Example 5

The aliphatic-aromatic polyester (Polyester C) used was Eastar Coployester 6763. It contained terephthalic acid and approximately 3 μmol % cyclohexanedimethanol and 69 mol % ethylene glycol. Its inherent viscosity was 0.73. The mineral filler used was NYGLOS 4W a Wollastonite with a median particle size of 4.5 microns and an aspect ratio of 11:1, available from Nyco Minerals, Inc., Willsboro, N. Y.

The aliphatic-aromatic polyester was dried at 70° C. and the wollastonite was not dried. Formulations were prepared in a 30 mm Werner-Pflieder twin screw extruder. The polyester and wollastonite were fed into the extruder by separate gravimetric feeders and the extruded strand was pelletized. The pellets were injection molded into parts on a Toyo 90 injection molding machine. The extruder was run at 350 rpms at a feed rate to give a machine torque between 80-100%. Processing temperatures used were in the range of 260° C. to 280° C. The compositions and properties of the blends are shown in Table 11. The weight percent of wollastonite was calculated from the gravimetric settings used on the feeders. The sample containing no filler was not extruded; typical properties after injection molding are shown for it.

TABLE 11

| | UNITS | | | | | |
|---|---|---|---|---|---|---|
| % Aliphatic-aromatic polyester C | % | 100 | 95 | 90 | 85 | 80 |
| % NYGLOS 4W | % | 0 | 5 | 10 | 15 | 20 |
| Heat Deflection Temperature 264 Psi | (deg C.) | 64 | 63 | 63 | 63 | 65 |
| Tensile Strength | MPa | 50 | 51 | 51 | 53 | 55 |
| Tensile Break Elongation | % | 130 | 71 | 19 | 17 | 14 |
| % Retained Break Elongation | | | 54.4 | 14.6 | 13.1 | 10.8 |
| Flexural Modulus | MPa | 2100 | 2086 | 2358 | 2608 | 3148 |
| Flexural Strength | MPa | 70 | 68 | 70 | 71 | 74 |

### Counter Example 6

The polyester used was the polycarbonate of 4,4′-isopropylidenediphenol (bisphenol A). The mineral filler used was NYGLOS 4W, a Wollastonite with a median particle size of 4.5 microns and an aspect ratio of 11:1, available from Nyco Minerals, Inc., Willsboro, N. Y.

The polycarbonate was dried at 90° C. and the wollastonite was not dried. Formulations were prepared in a 30 mm Werner-Pflieder twin screw extruder. The polycarbonate and wollastonite were fed into the extruder by separate gravimetric feeders and the extruded strand was pelletized. The pellets were injection molded into parts on a Toyo 90 injection molding machine. The extruder was run at 350 rpms at a feed rate to give a machine torque between 80-100%. Processing temperatures used were in the range of 270° C. to 290° C. The compositions and properties of the blends are shown in Table 12. The weight percent of wollastonite was calculated from the gravimetric settings used on the feeders. The sample containing no filler was not extruded; typical properties after injection molding are shown for it.

TABLE 12

| | UNITS | | | | | |
|---|---|---|---|---|---|---|
| % Polycarbonate polyester | % | 100 | 95 | 90 | 85 | 80 |
| % NYGLOS 4W | % | 0 | 5 | 10 | 15 | 20 |
| Heat Deflection Temperature 264 Psi | (deg C.) | 128 | 126 | 126 | 125 | 125 |
| Tensile Strength | MPa | 71 | 64 | 66 | 68 | 62 |
| Tensile Break Elongation | % | 132 | 54 | 46 | 14 | 3 |
| % Retained Break Elongation | | | 40.9 | 34.8 | 10.6 | 2.3 |
| Flexural Modulus | MPa | 2386 | 2402 | 2662 | 3012 | 3703 |
| Flexural Strength | MPa | 98 | 96 | 98 | 103 | 70 |

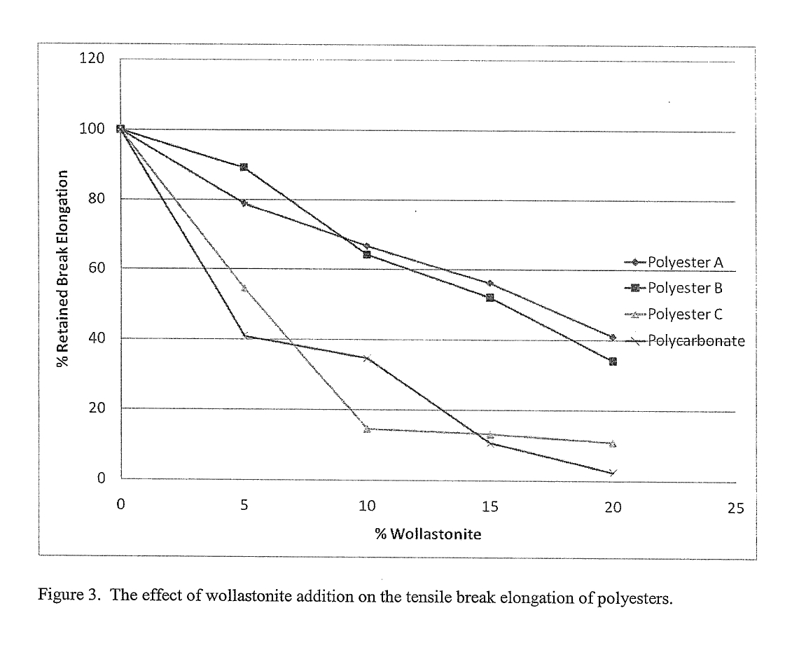

To better illustrate the effect of wollastonite addition on the polyesters of the above examples, the % retained break elongation is plotted as a function of wollastonite level in FIG. 3. It is clear from this figure that effect of wollastonite addition to these polyesters is similar to the effect observed for talc and calcium carbonate addition discussed previously. Addition of 10% wollastonite results in less than 40% tensile retention for polyester C and polycarbonate used as comparative examples. In contrast, for Polyesters A and B, which are used as examples for this invention, the retained tensile break elongation is greater than 60% upon addition of 10% wollastonite. For higher levels of wollastonite addition, significantly higher retained break elongations are also seen for Polyesters A and B compared to Polyester C and polycarbonate.

The invention has been described in detail with reference to the embodiments disclosed herein, but it will be understood that variations and modifications can be effected within the spirit and scope of the invention.

We claim:

1. A polyester composition comprising:
a polyester which comprises: at least 50 mole percent terephthalic acid residues; from about 2 to 100 mole percent 2,2,4,4-tetramethyl-1,3-cyclobutanediol residues; and from 0 to about 98 mole percent 1,4-cyclohexanedimethanol residues, wherein the total mole percent of dicarboxylic acids in the polyester is 100 mole percent, and the total mole percent of diols in the polyester is 100 mole percent; and
a mineral filler.

2. The polyester composition of claim 1, wherein the mineral filler comprises one or more of: talc, wollastonite, mica, calcium carbonate, kaolin clay, montmorillonite clay, feldspar, nepheline syenite, silica, aluminum silicate, barium sulfate, barite, or zinc sulfide.

3. The polyester composition of claim 1, wherein the mineral filler comprises particles of one or more of the following: talc, wollastonite, or calcium carbonate.

4. The polyester composition of claim 1, wherein the mineral filler comprises particles having one or more of the following forms: platelet, acicular, fibrous, cube, block, spherical, or irregular.

5. The polyester composition of claim 1, wherein the mineral filler comprises particles having one or more of the following forms: platelet, acicular, or irregular.

6. The polyester composition of claim 1, wherein the polyester comprises at least 70 mole percent terephthalic acid residues.

7. The polyester composition of claim 1, wherein the polyester comprises at least 90 mole percent terephthalic acid residues.

8. The polymer composition of claim 1, wherein the 2,2,4,4-tetramethyl-1,3-cyclobutanediol residues are present in the polyester in an amount from 5 to 100 mole percent, and the 1,4-cyclohexanedimethanol residues are present in the polyester in an amount from 0 to 95 mole percent.

9. The polymer composition of claim 1, wherein the polyester is present in an amount from 60 wt. % to 98 wt. %, and the mineral filler is present in an amount from 2 wt. % to 40 wt. %, with respect to the total weight of the blend.

10. The polymer composition of claim 1, wherein the polyester is present in an amount from 70 wt. % to 95 wt. %, and the mineral filler is present in an amount from 5 wt. % to 30 wt. %, with respect to the total weight of the polyester composition.

11. The polymer composition of claim 1, wherein the polyester consists essentially of terepthalic acid residues, 2,2,4,4-tetramethyl-1,3-cyclobutanediol residues, and 1,4-cyclohexanedimethanol residues.

12. The polymer composition of claim 1, wherein the inherent viscosity of the polyester is at least 0.5 dL/g, determined at 25° C. in 60/40 wt/wt phenol/tetrachloroethane.

13. The polyester composition of claim 1, wherein the mineral filler comprises particles of talc.

14. The polyester composition of claim 1, wherein the mineral filler comprises particles of wollastonite.

15. The polyester composition of claim 1, wherein the mineral filler comprises particles of calcium carbonate.
